(19) United States
(12) Patent Application Publication
(10) Pub. No.: US 2014/0207494 A1
(43) Pub. Date: Jul. 24, 2014

(54) SYSTEM AND METHOD FOR SELLING INTANGIBLE PROPERTY

(71) Applicant: Fidelity Life Association, Oakbrook, IL (US)

(72) Inventor: Michael Rowell, Medina, WA (US)

(73) Assignee: Fidelity Life Association, Oakbrook, IL (US)

(21) Appl. No.: 14/158,340

(22) Filed: Jan. 17, 2014

Related U.S. Application Data
(60) Provisional application No. 61/754,355, filed on Jan. 18, 2013.

(51) Int. Cl. G06Q 40/08; G06Q 30/06

(52) U.S. Cl. CPC G06Q 40/08; G06Q 30/0631
USPC 705/4

(57) ABSTRACT

A system and methods to enable a consumer or agent to purchase intangible products, such as life insurance, are disclosed. The system is a workflow implementation system that processes a consumer through the purchase process, updating the consumer at various points with options of intangible products available for purchase. In various embodiments, the system presents cross-sell opportunities in the form of other intangible products that the customer has not specifically indicated an interested in purchasing, but that the consumer qualifies or potentially qualifies for that the system has determined may be of interest.

### PRIORITY CLAIM

This application is a non-provisional of, and claims priority to and the benefit of U.S. Provisional Patent Application No. 61/754,355, filed on Jan. 18, 2013, which is incorporated by reference herein in its entirety.

### COPYRIGHT NOTICE

A portion of the disclosure of this patent document contains material that is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### TECHNICAL FIELD

The present disclosure relates in general to a system and method for facilitating the distribution of an intangible product through the implementation of a state-based workflow process. More specifically, the present disclosure relates to a system and method for establishing a web-based sales lead marketplace and for distributing sales leads to salespeople using the online sales lead marketplace.

### BACKGROUND

Insurance agents spend the majority of their time tracking, following-up, and processing their sales and very little time actually selling.

Moreover, currently known systems do not enable both Agents and Consumers to access a central information resource to facilitate the buying process for either an Agent (i.e., on behalf of a consumer) or the consumer himself or herself. Thus, known systems do not possess the flexibility to enable users of different types, whether sales agents or consumers themselves, to access the system and to be guided through a workflow to enable the purchase of an intangible product.

Additionally, known systems do not include the capability to recommend particular products to consumers based on details about the consumers. Specifically, known systems do not enable a consumer to input information about him or herself, analyze the information provided by the consumer, and suggest one or products that might be both ideally suited to the consumer and available for purchase based on the consumer's personal information.

Accordingly, there is a need for a new system and method for implementing a workflow management process in which the workflow of Agents, Consumers, or other types of computer users can be implemented, and the appropriate rules followed, during the purchase of an intangible product such as life insurance.

### SUMMARY OF THE DISCLOSURE

The present system and method was developed specifically to increase the volume of insurance an agent could sell. It applies equally to any other intangible product such as mortgages, even though the explanation below focuses on insurance.

In one embodiment, a computerized system as disclosed herein enables numerous different types of users, such as Agents or Consumers, to access a server system using a client system. In this embodiment, the system guides the user (whether the user is an Agent or a Consumer) through a workflow needed to purchase an intangible product, such as insurance. The disclosed system in various embodiments is integrated with one or more third party systems as necessary for the workflow enabled by the system.

In one embodiment, throughout the purchase process of the intangible product, the disclosed system enables quotes to be displayed and accepted, as appropriate, either to an Agent or a Consumer operating a client computer. Moreover, in various embodiments, the disclosed system continually receives additional information about the purchaser, and enables the information about the purchaser to be used to refine quotes presented and products offered for purchase.

In one embodiment, the disclosed system also provides for a product recommendation wizard. In this embodiment, the product recommendation wizard utilizes information provided by the consumer or agent during the purchase process to recommend one or more products for purchase. In various embodiments, the products recommended for purchase are products that the system determines to be particularly relevant to the purchaser, or are products that are particularly likely to be available based on information about the purchaser.

Additional features and advantages are described in, and will be apparent from, the following Detailed Description and the figures.

### BRIEF DESCRIPTION OF THE FIGURES

FIG. 1 is a flow diagram of a method according to an embodiment of the invention.

FIG. 2 is a block diagram showing one example of a host device architecture for implementing the information distribution system disclosed herein.

FIG. 3 is a schematic representation of the architecture an functional requirements for an embodiment of the system disclosed herein.

FIG. 4 is a schematic diagram of the product recommendation engine of one embodiment of the disclosed system.

FIG. 5 is a schematic illustration of the product recommendation wizard interface provided to an agent in one embodiment during the quoting phase of the purchase process.

FIG. 6 is a schematic illustration of a product recommendation details page provided to an agent in one embodiment of the disclosed system.

FIG. 7 is a schematic illustration of a system architecture disclosed herein.

FIG. 8 is a schematic illustration of a system architecture disclosed herein similar to that illustrated in FIG. 7.

### DETAILED DESCRIPTION

In one embodiment, the system disclosed herein is a configurable, integrated business process engine configured to guide an agent and/or a consumer through the entire sales process for the purchase of intangible property. In this embodiment, the guiding process spans a point in time at which a lead is received through the collection of information about the user, a quoting and product recommendation phase, an application fulfillment phase, a phase involving cross-selling and requirements handling, and culminating in an offer presentation. In various embodiments, these workflows are implemented as either predefined rules that are configured into the system or by a predictive model that makes suggestions for the best outcomes. In various embodiments, the disclosed system can present differing user interfaces, depending on whether an agent or a consumer is accessing the disclosed system. In various embodiments, the disclosed system is integrated with third party products, such as third party information databases, to facilitate the sale of intangible products. In an embodiment, the disclosed system guides the user (e.g., either an agent or a consumer) through the purchase process using a scripting model. Workflow and guidance may vary based on lead & product rules, analytical data and roles, as will be described in more detail below.

In one embodiment, one of the main objectives of the system disclosed herein is to create an easy-to-use and seamless sales experience for both an agent and a consumer. In a further embodiment, the disclosed system ensures that the agent is not deviating from the prescribed and proven process, again ensuring a high quality experience.

In an embodiment, a key differentiating factor of the disclosed system over known systems is that quotes, product recommendations, and cross selling options are provided to agents and/or consumers throughout the process. In this embodiment, the specificity and relevance of these quotes, recommendations, and cross selling opportunities improves as consumer information is gathered.

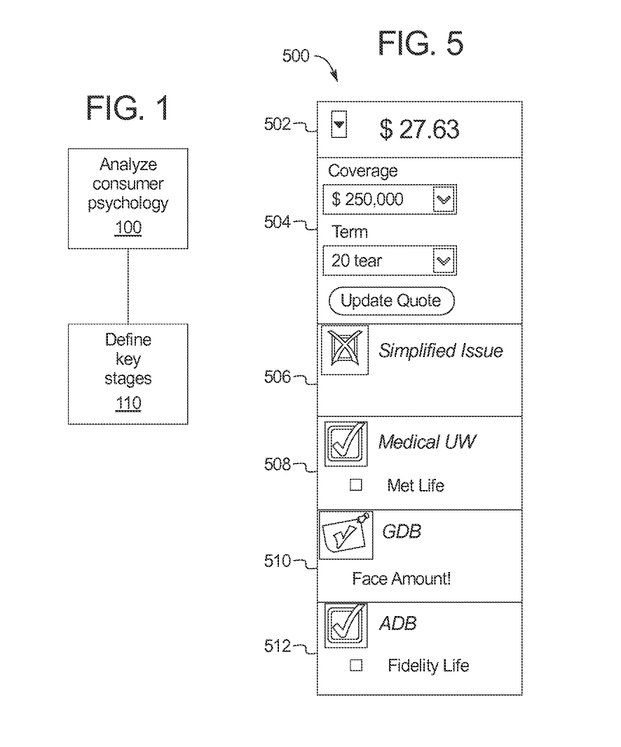

Referring now to FIG. 1, part of the development of this system and method includes analyzing 100 the psychology of the typical consumer and defining 110 key stages where customers drop out and other key stages where sales could be maximized. This system and method addresses the lengthy process required to buy life insurance by establishing what events must occur to move a customer through the process as quickly as possible with as little of effort by the selling agent.

The disclosed system and method is all inclusive for tracking and management of leads, including how leads are purchased, entered, distributed, emailed, monitored, and completely managed as they flow through the sales cycle.

All sales of intangible property such as life insurance follows the same general sales cycle from start to finish. A lead is imported or entered into the system. The prospective customer is then contacted, given a quote, and often agrees to purchase a policy. The customer must then complete an application that is specific to the state and company for which they are seeking insurance or other intangible product. The customer is also required to complete a medical exam.

Upon completing both the medical exam and application, the customer's information is sent off to the life insurance company where it will be reviewed by an underwriter. The underwriter uses predetermined underwriting guidelines to evaluate the customer's risk of death and place them into an appropriate rating classification. The rating classification determines the price for insurance the customer will be paying. Upon approval of the policy, the insurance company issues a policy and forwards it to the agent. The agent is then responsible for getting that policy to the customer and collecting any delivery requirements the insurance company has requested. The agent submits the delivery requirements to the insurance company and then follows up with the customer periodically.

Sales Cycle Breakdown:

New Lead—Gold, Silver, Bronze

New Applicant

Medical Complete

Paperwork Complete

Underwriting

Approved

Policy Sent

Client

Future Call Back

Dead File

### Sales Cycle Definitions:

New Lead

Someone that has requested an agent to call them and give them a quote for insurance.

### New Applicant

Someone that has agreed to purchase a policy and you have mailed the application out to them and ordered the medical exam.

Medical Complete

The customer has completed the medical exam but you are still waiting for their application.

Paperwork Complete

Opposite of medical complete. They have completed the application but have not completed the medical exam.

Underwriting

Person has completed both the medical and application and is being reviewed by an underwriter for the coverage they are requesting.

Approved

Policy has been approved and the agent is awaiting the policy from the insurance company.

Policy Sent

Policy was received and mailed out to the customer.

Client

Policy was successfully delivered and all money and signatures to complete the transaction were completed.

Future Call Back

Someone that is a prospect in the future for insurance. Usually you spoke to them and they asked you to contact them at a later date.

Dead File

Someone you were either unable to contact or after contacting them you determined that they are not going to be a prospect for the insurance.

This system and method additionally includes several reporting features for agents and agencies to spot problem areas in their business. The system allows for users to run reports on their business to see average case sizes, number of people in each sales stage, and graphical analysis of a user's book of business.

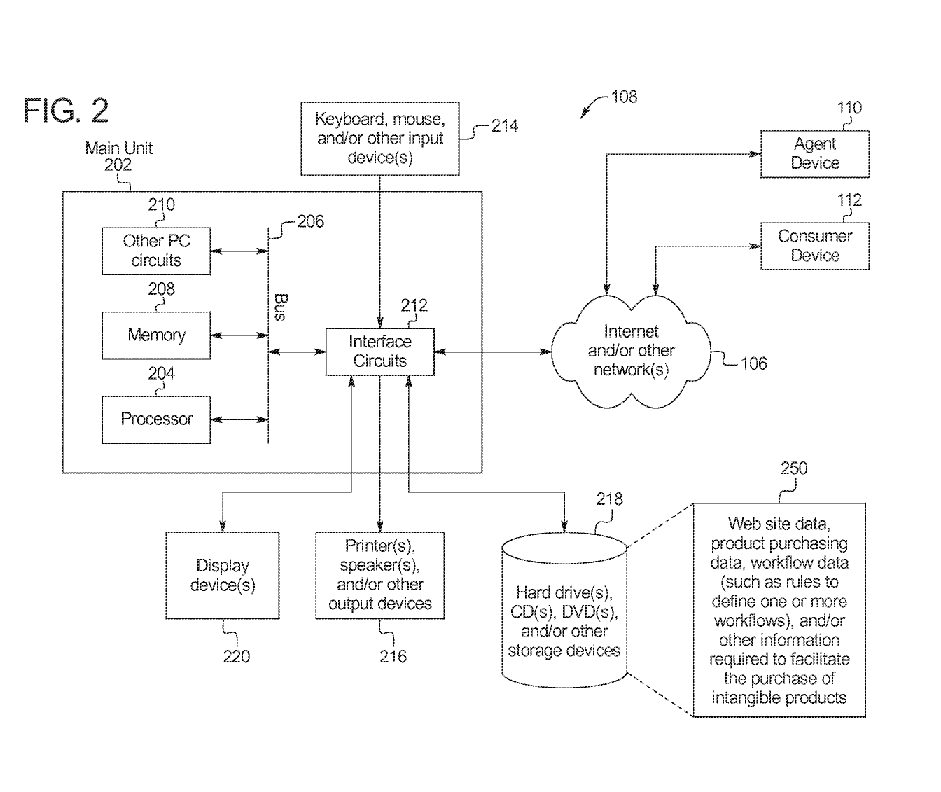

FIG. 2 is a block diagram illustrating an example of the electrical systems of a host device (e.g., host device 108) usable to implement the information distribution system disclosed herein. In one embodiment, the host device 108 corresponds to a workflow implementation system whose functions and capabilities will be discussed in more detail below.

In the example architecture illustrated in FIG. 2, the host device 108 includes a main unit 202 which preferably includes one or more processors 204 electrically coupled by an address/data bus 206 to one or more memory devices 208, other computer circuitry 210, and one or more interface circuits 212. The one or more processors 204 may be any suitable processor, such as a microprocessor from the INTEL PENTIUM® family of microprocessors. PENTIUM® is a trademark registered to Intel Corporation and refers to commercially available microprocessors.

In one embodiment, host device 108 includes memory 208. Memory 208 preferably includes volatile memory and non-volatile memory. Preferably, the memory 208 stores one or more software programs that interact with the other devices in the system as described below. In addition or alternatively, these programs may interact with one or more consumer or agent to facilitate the sale of intangible products, such as insurance products, as discussed below. These programs may be executed by the processor 204 in any suitable manner. The memory 208 may also store digital data indicative of intangible information, such as sales leads, customer information, product information, documents, files, programs, web pages, etc. received from either an agent device 110, a consumer device 112, or some other appropriate source.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual representations of data during operation of the host device 108. For example, the display 220 may be used to display a representation of a position in a workflow of a consumer or agent during the purchase process. Alternatively or in addition, the display 220 may be utilized to display reporting or other statistical information about the sales activity facilitated by host device 108.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the host device 108. In one example described in more detail below, the storage device 218 stores database information in a database 250 including web site data, product purchasing data, workflow data (such as rules to define one or more workflows), and/or other information required to facilitate the purchase of intangible products by users at either the agent device 110 or the consumer device 112. Further, the storage device 218 may also include database files that contain information needed to facilitate the workflow system disclosed herein, such as web site information, purchasing software including software to enable a user to purchase an intangible product (e.g., by providing credit card information) and the like.

In one embodiment, the host device 108 exchanges data with both the agent device 110 and the consumer device 112. In a further embodiment, the disclosed system enables a plurality of agent devices, such as device 110, and a plurality of consumer devices, such as device 112, to communicate with the host device 108 such that information can be exchanged by and between users at each of those devices.

Preferably, this connection of devices (i.e., the host device 108, the agent device 110, and the consumer device 112) is facilitated by a network connection over the Internet and/or other networks, illustrated in FIG. 1 by cloud 106. The network connection may be any suitable network connection, such as an Ethernet connection, a digital subscriber line (DSL), a WiFi connection, a cellular data network connection, a telephone line-based connection, a connection over coaxial cable, etc.

Access to a host device 108, agent device 110, and/or consumer device 112 may be controlled by appropriate security software or security measures. An individual user's access can be defined by the host device 108 and limited to certain data and/or actions. Accordingly, users of the system may be required to register with one or more host devices 108, agent devices 110, and/or consumer devices 112 prior to engaging in the lead purchasing and management activities facilitated by the disclosed system.

In a preferred embodiment, each of the agent devices 110 and consumer devices 112 has a similar structural makeup to that described above with respect to the host device 108. That is, each agent device and consumer device includes a display device, at least one input device, at least one memory device, at least one storage device, at least one processor, and at least one network interface device. It should be appreciated that by including such components, which are common to well-known desktop, laptop, or mobile computer systems (including smart phones, tablet computers, and the like), agent devices 110 and consumer devices 112 facilitate interaction among and between each other by users of the respective systems.

In one embodiment, the system disclosed herein needs to be able to retrieve lead information from an associate lead system, which constitutes a database and repository of leads of potential buyers of a product. In this embodiment, the disclosed system has appropriate access to the lead system to enable it to modify lead information and to create new leads as appropriate. In this embodiment, the disclosed system can communicate information about modification or creation of new leads to the lead system, which is then able to update its own internal databases to reflect the modified or new lead information. In various embodiments, the disclosed system is configured to analyze and profile lead information, such that product recommendation and workflow management can be more easily achieved. In an embodiment, the disclosed system enables a system administrator to store and/or modify one or more lead rules, defining the use of leads and criteria about recommendations made based on leads.

In one embodiment, the disclosed system is further configured to manage interaction with a consumer, such as when a consumer accesses the disclosed system from a remote system for the purpose of purchasing an intangible product. In this embodiment, the disclosed system maintains data indicating a current workflow position and the state of completion for a consumer's purchase process. In one embodiment, lead rules and/or lead types drive the workflows enabled by the disclosed system. In a further embodiment, the disclosed system relies on predictive analytics to drive the workflow process for a particular consumer's purchase of an intangible product. In an embodiment, the disclosed system provides ad verbatim scripting and scripted guidance for each workflow step. In a further embodiment, status information about the completion or non-completion of each step in the workflow is available to indicate close-out conditions for a step of a workflow, and to indicate the reasons for close-out or non-close-out.

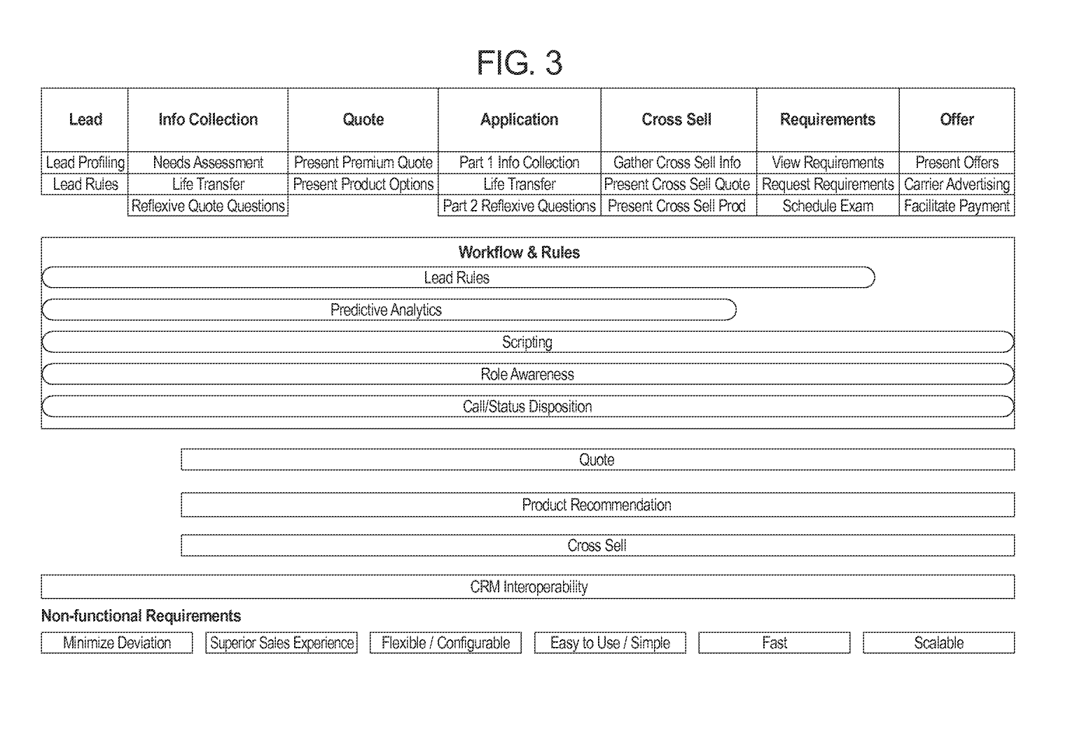

FIG. 3 is a schematic representation of the architecture an functional requirements for an embodiment of the system disclosed herein.

In various embodiments, the characteristics defining the workflows described herein are configurable, such that quick modifications to the workflow are possible using the disclosed system. Specifically, in one embodiment, lead rules, indications of required consumer information, related scripting and script guidance information are user configurable by and administrator or other user with appropriate privileges to enable quick modifications of the disclosed workflows.

In one embodiment, the system disclosed herein includes a so-called product recommendation engine component. In one such embodiment, the product recommendation engine is a combination of software and hardware to execute the software, running on the host device 108, that is configured to process information from different information sources to determine and then recommend one or more products determined to be a best fit for a consumer.

In an embodiment, the disclosed system uses predictive analytics to provide recommendations for a particular consumer. In this way, the disclosed system can analyze past decisions and product sales, compare the parameters and criteria associated with those sales, and predict a potentially useful product for a current consumer. In one embodiment, predictive analytics capabilities of the disclosed system are based on historical sales data, predefined lead rules from lead source information and customer needs and preferences gathered during an interview process.

In one embodiment, the disclosed system also bases its predictions on precise quoting of prices for products according to a wide universe of known information. In this embodiment, the disclosed system consolidates its product sales rules and premium rates across multiple carriers of an intangible product. By so consolidating, the disclosed system can utilize consistent product rules and premium rates across multiple carriers, and can therefore make predictions based on more standardized and less carrier-specific information.

In one embodiment, the disclosed product recommendation engine is configured to interact with a plurality of third party systems to obtain data about sales made through those systems. For example, the disclosed product recommendation engine in one embodiment is configured to interact, using an electronic interface, with one or more systems of one or more carriers of an insurance product. In this way, the disclosed product information engine can make recommendations based not only on information it has gathered, but also using information available to it from other, third-party sources.

In one embodiment, the disclosed system provides a particular product and quote to a consumer or agent based on preliminary information about the purchaser. At this point, the consumer can decide whether to go forward with the provided product and quote. In this embodiment, once a consumer decided to go forward with a particular product or quote, the disclosed system gathers so-called “Part I” information for the application for purchase of the intangible product. In one embodiment, an agent using the disclosed can warm transfer the consumer to a third party (which will actually be selling the product) for the fulfillment of the application. In this embodiment, the disclosed system provides the third party with the capability to access the particular case for the warm-transferred purchaser. Thus, the disclosed system provides an interface usable by third parties to access information about a consumer already inputted into the system, such that the third party can continue with and consummate the sale. In one embodiment, information gathered during the quoting process is pre-populated into the application to reduce redundant work and to ensure a positive consumer experience.

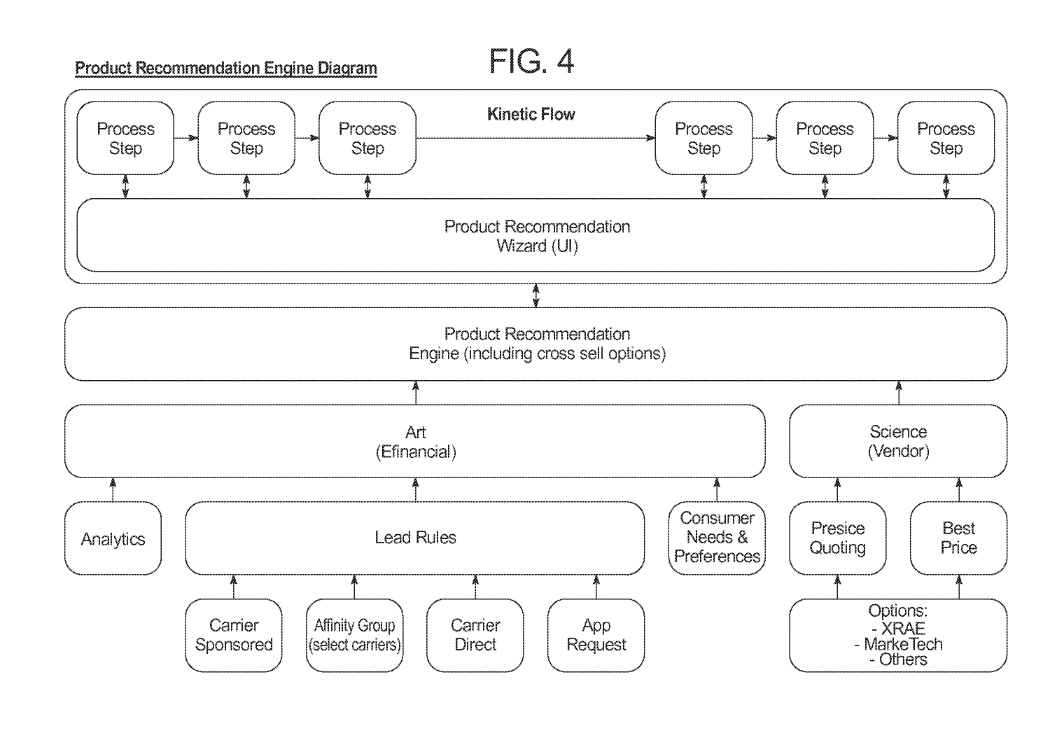

FIG. 4 is a schematic diagram of the product recommendation engine of one embodiment of the disclosed system. In the example diagram, the portion of the system encompassed in the box labeled “Workflow System” represents the workflow process enabled by the disclosed system. Specifically, in the illustrated embodiment, the six “Process Step” blocks represent steps in the workflow for the purchase of an intangible product, such as life insurance.

The block labeled “Product Recommendation Wizard (UI)” of FIG. 4 represents a user interface provided by the disclosed system to recommend certain products to a particular user at various points during the workflow process. In this embodiment, the block labeled “Product Recommendation Engine” represents the logic for determining recommendations of products for a user to purchase. In one embodiment, the disclosed system provides product recommendations throughout the entire process as consumer information is gathered. In this embodiment, it is the illustrated “Product Recommendation Wizard” that is responsible for providing such recommendations to the user, which may be an agent or a consumer. In an embodiment, the wizard provides product recommendations grouped by product types. For example, the disclosed system in one embodiment provides product offerings grouped as simplified issue products (products which require very little underwriting to issue), medical underwriting products (products that require more medial underwriting to issue), general death benefit or “GDB” products, and accidental death benefit or “ADB” products.

In an embodiment, the disclosed system displays the monthly premiums of a suggested product by the product recommendation engine to an agent at any time. In this embodiment, well as what product types the consumer is qualified for. The system will indicate if coverage amount or guarantee period are factors for product availability. In this embodiment, the agent can adjust coverage amount and guarantee periods during the purchase process. In this embodiment, the system thus enables the agent to move the consumer to a different product type, such as GDB product or an ADB product, early in the process should the consumer not qualify for a simplified issue or medical product. This feature also enables the agent to move the consumer to a different product type if the premium rate for a recommended product exceeds the consumer's budget. In one embodiment, the Product Recommendation Wizard enables the agent to access additional information about the carriers, products and reasons for the quote decision. In an embodiment, the disclosed system provides a score for each available product suggesting the best fit for the consumer.

In varying embodiments, the presentation of information by the Product Recommendation Wizard varies if the user is a consumer versus if the user is an agent. FIG. 5 illustrates a schematic illustration of the product recommendation wizard 500 interface provided to an agent in one embodiment during the quoting phase of the purchase process. In this embodiment, the wizard includes a top section 502 that contains a current premium quote based on the other information displayed in the wizard. Section 504 displays an indication of the coverage amount and term of the currently quoted product. Section 506, 508, 510, and 512 display an indication of whether four different types of product, specifically a simplified issue, medical underwriting, general death benefit, and accidental death benefit, product, are available for purchase in the requested amounts. In the illustrated embodiment, the agent can modify the inputs to the wizard by changing a desired premium amount, a desired coverage amount, or a desired term of coverage. By clicking the update quote button, 514, the agent can cause the wizard to display available products at the new set of parameters. Thus, FIG. 5 illustrates how an embodiment of the Product Recommendation Wizard can provide a set of changeable inputs to an agent, and can display available products matching provided parameters.

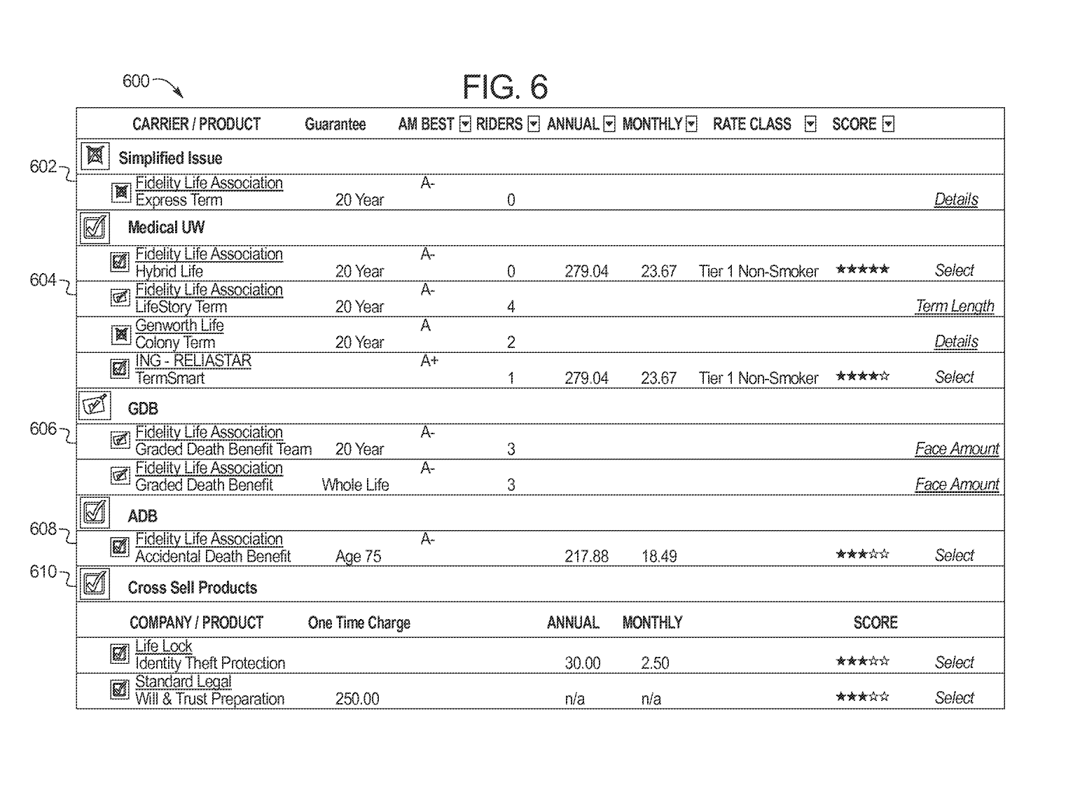

FIG. 6 is a schematic illustration of a product recommendation details page provided to an agent in one embodiment of the disclosed system. In this embodiment, the page 600 includes five different areas 602, 604, 606, 608, and 610. Each area corresponds to a different kind of product, including simplified issue, medical underwriting, general death benefit, accidental death benefit, and cross-sell products. For each product, a plurality of columns is provided. In the illustrated embodiment, the columns include a Guarantee column indicating the term of the product, a plurality of columns related to the details of the product (such as rate class, an indication of the number of riders, etc.), and other information related to each type of product. In the illustrated embodiment of FIG. 6, the first four areas 602, 604, 606, and 608 correspond to the sections 606, 608, 610, and 612 displayed in the Wizard of FIG. 5.

The embodiment of FIG. 6, however, also includes an area for cross sell products, which indicate one or more products that might be interesting to the purchaser, despite the fact that the purchaser has not indicated a particular desire to purchase those products. In this embodiment, the disclosed system is configured to determine additional potential needs of a consumer. In various embodiments, while servicing the consumer with the lead product, additional needs may surface through information gathered from the consumer or additional needs will be derived through predictive analytics of the customer profile. The disclosed system thus enables the presentation of cross sell product offerings, such as illustrated in area 610 of FIG. 6. Cross sell product offerings in one embodiment are provided by the product recommendation engine in a similar way as the lead product options, however, these products may not directly match the criteria or parameters provided about what kinds of products the customer is interested in.

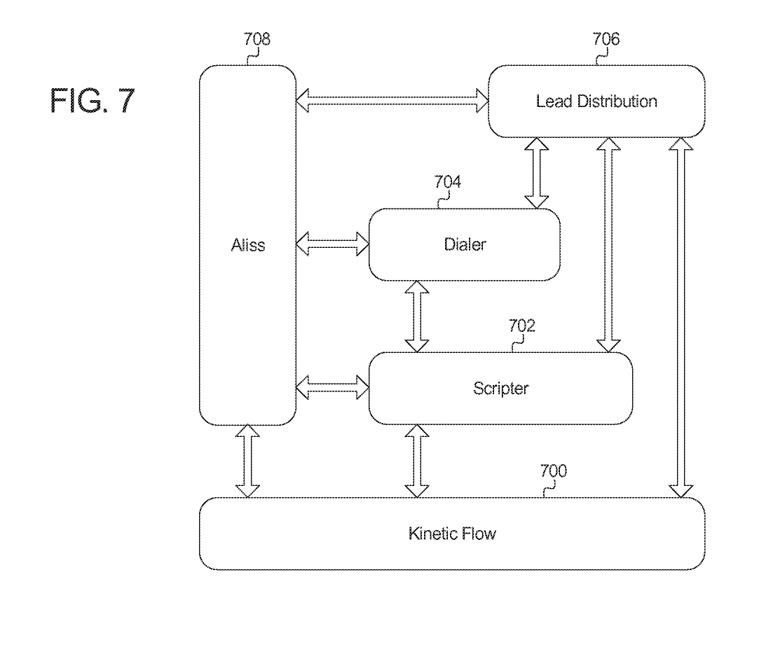

In one embodiment, the disclosed system is not designed to be a customer relationship management (CRM) system. In this embodiment, the disclosed system is configured to interface with one or more other CRM systems to access CRM services and functionality. The illustration in FIG. 7 shows one system architecture, in which the Workflow System 700 is configured to interface with and interact with a scripter 702 for scripting the appropriate workflows, a dialer 704 for dialing customers as necessary, a lead distribution system 706 for providing leads to the dialer, the scripter, and the disclosed Workflow System, and a CRM system 708 to manage the customer's status within the system. In this embodiment, the disclosed system is configured to handle the workflow related to enabling the purchase of certain intangible products, such as life insurance products, as disclosed herein. Specifically, the disclosed system handles receipt of information pertinent to which products are available, and also recommends other products as described elsewhere herein.

In an embodiment, the disclosed system is configured to be used by call center agents as well as wholesale agents and therefore is not dependent on any telephony integration. In this application, the scripter application 702 of FIG. 7 can be used to efficiently connect a consumer with call center agent or other representative of the company providing the disclosed system. In this embodiment, consumer information collected in the scripter application is provided to the disclosed system, to enable the disclosed system to make the appropriate recommendations regarding products the user may be interested in purchasing. In one embodiment, the lead distribution application X06 is configured to provide a prospect list to the agent, taking into consideration lead and agent information.

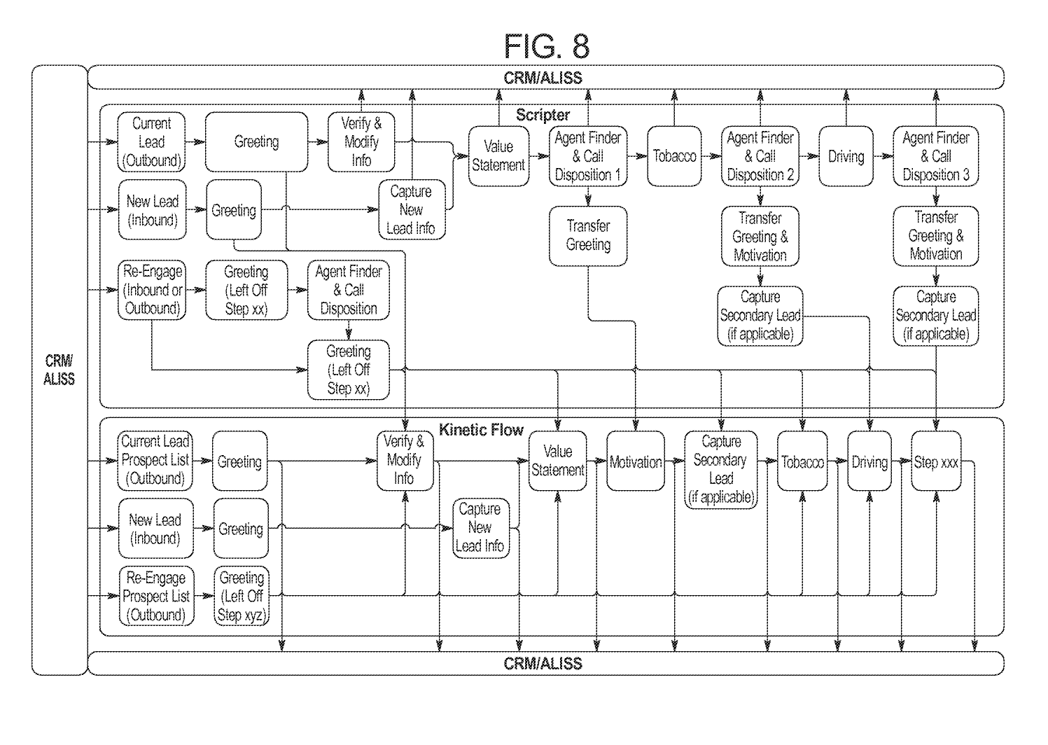

The diagram of FIG. 8 further illustrates the interaction between the disclosed system, the scripter application 702, and the CRM application 708.

The above description of is exemplary of the features of the system disclosed herein. As noted, the disclosed system could be used to sell any type of information to any type of purchaser of information, and is not limited to selling sales leads. Moreover, the functionality of the above-described system is not limited to the functionalities indicated herein. It should be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A workflow implementation system comprising:
at least one processor;
at least one network interface device; and
at least one memory device which stores a plurality of instructions which, when executed by the at least one processor, cause the at least one processor to operate with the at least one network interface device to:
(a) enable information about a prospective customer to be provided, said information including at least one indication of a desired life insurance coverage;
(b) determine that at least one piece of additional information about the customer is needed;
(c) display an indication requesting the at least one piece of additional information about the customer;
(d) receive the at least one piece of additional information;
(e) display an indication of at least one product for which the customer is eligible based on the information about the prospective customer and the at least one piece of additional information about the customer; and
(f) display a recommendation of at least one additional product as a cross sell opportunity based on the information about the prospective customer and the at least one piece of additional information about the customer, wherein the at least one additional product is not a product the customer is known to be interested in purchasing.
